(19) United States
(12) Patent Application Publication
(10) Pub. No.: US 2004/0227304 A1
(43) Pub. Date: Nov. 18, 2004

(54) Sealing Ring

(75) Inventors: Hermann Kern, Flein (DE); Dieter Meister, Mockmuhl (DE); Joachim Reichert, Talheim (DE); Kai-Uwe Rettenmeier, Beilstein (DE); Thomas Schwarz, Leingarten (DE)

Correspondence Address: GUDRUN E. HUCKETT DRAUDT, LONSSTR. 53, WUPPERTAL, 42289, DE

(73) Assignee: KACO GMBH + CO. KG, Heilbronn (DE)

(21) Appl. No.: 10/708,741

(22) Filed: Mar. 23, 2004

(30) Foreign Application Priority Data
Mar. 25, 2003 (DE) 103 13 162.0

(51) Int. Cl. F16J 15/32

(52) U.S. Cl. 277/559

(57) ABSTRACT

A sealing ring has a support member and a sealing lip connected to the support member. The sealing lip rests against a machine part to be sealed. The sealing lip has a passage for the machine part, wherein the passage points to an air side of the machine part to be sealed and has a contact side provided with a return conveying device for a medium to be sealed at a medium side of the machine part. The return conveying device is an alternating twist structure that is formed by angularly staggered, crossing elliptical structures, crossing straight structures, sine-shaped structures, or arcs.

### BACKGROUND OF INVENTION

1. Field of the Invention

The invention relates to a sealing ring comprising a support member and a sealing lip resting against a machine part to be sealed, especially a shaft, wherein a passage of the sealing lip points toward the air side and is provided at its contact side with a return conveying device for the medium to be sealed present at the medium side.

2. Description of the Related Art

Sealing rings are known that have a sealing lip that is formed by a radial inner part of a sealing disk that is comprised of polytetrafluoroethylene and is bent in the direction toward the air side. The return conveying device for returning the medium that has penetrated from the medium side into a sealing area underneath the sealing lip is embodied as a spiral. Therefore, the sealing ring can be used only in a single rotational direction.

### SUMMARY OF INVENTION

It is an object of the present invention to configure a sealing ring of the aforementioned kind such that it can be used for both, i.e., alternating, rotational directions.

In accordance with the present invention, this is achieved in that the return conveying device is configured as an alternating twist structure.

In the sealing ring according to the invention, the return conveying device for the medium is configured as an alternating twist structure with which the medium penetrating from the medium side a sealing area underneath the sealing lip is reliably returned to the medium side. As a result of the alternating twist configuration, the medium is first conveyed in the direction toward the sealing edge and subsequently away from the sealing edge back to the medium side. In this way, it is reliably prevented that the medium to be sealed can pass underneath the sealing lip to the air side.

### BRIEF DESCRIPTION OF DRAWINGS

FIG. 1 is an axial section of one half of a sealing ring according to the invention.

FIG. 2 is a first embodiment of a return conveying device of the sealing ring according to FIG. 1.

FIG. 3 is a second embodiment of a return conveying device of the sealing ring according to FIG. 1.

FIG. 4 is a third embodiment of a return conveying device of the sealing ring according to FIG. 1.

FIG. 5 is a fourth embodiment of a return conveying device of the sealing ring according to FIG. 1.

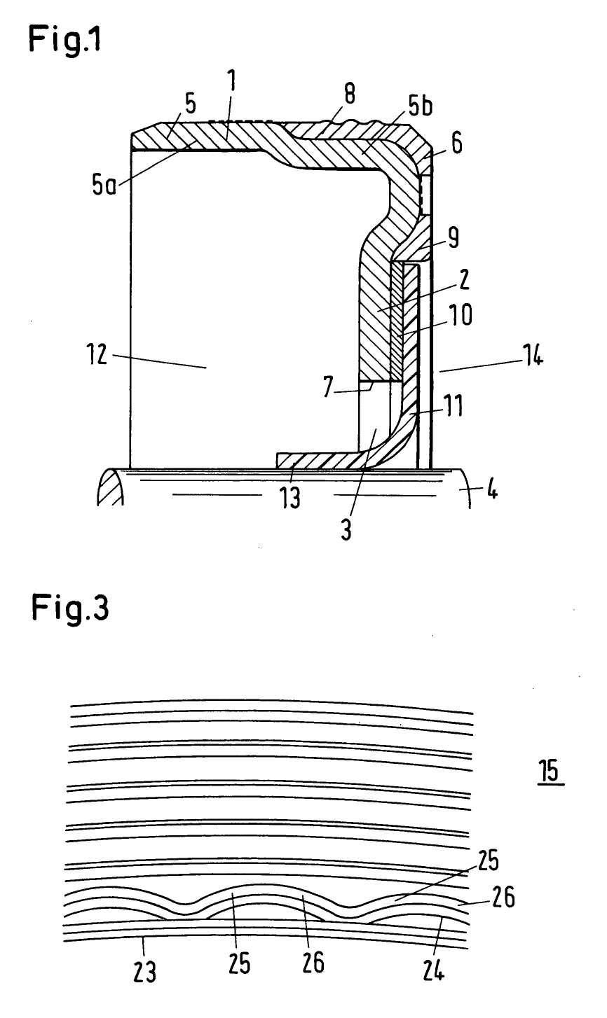

### DETAILED DESCRIPTION

The sealing ring in the illustrated embodiment is a radial rotary shaft seal and has a cup-shaped support member 1 that is comprised of metal or a hard plastic material. The support member 1 has a radially extending bottom 2 that is provided with a central passage 3 for passing the shaft 4 to be sealed therethrough. The bottom 2 passes into an outer wall 5 that is positioned coaxially relative to the shaft 4 and is comprised of a radially outwardly positioned wall section 5a and a radially inwardly positioned wall section 5b. The two wall sections 5a, 5b pass into one another with a step. The radially inwardly positioned wall section 5b has on its outer side a cover 6 that is comprised of elastomer material. The cover 6 extends across the outer side of the bottom 2 and can also cover the end face 7 that delimits the passage 3. In the area of the wall section 5b, the cover 6 is provided at the exterior side with an undulated profile 8. In the mounted position, this undulated profile 8 is elastically deformed so that the rotary shaft seal rests against the inner wall of the mounting space and provides a proper sealing action. By means of the radially outwardly positioned wall section 5a the rotary shaft seal is seated with press-fit in the mounting space while the cover 6 surrounding the wall section 5b forms a static seal.

The part of the cover 6 covering the bottom 2 of the support member 1 has a step 9 that separates a thick cover section from a thin cover section 10. On the thin cover section 10 a radially extending part of a sealing disk 11 is fastened that is comprised of polyfluorocarbon, preferably polytetrafluoroethylene (PTFE), an elastomer, or elastomer-modified PTFE (EMP—elastomer-modified PTFE). The sealing disk 11 is connected, as is known in the art, to the support member 1, preferably by plasma treatment. The radially inwardly positioned end of the sealing disk 11 is elastically bent relative to the air side 12 and forms the dynamic sealing part 13.

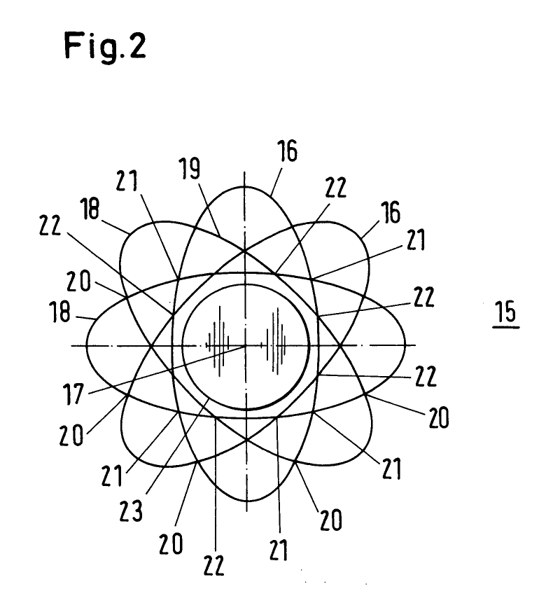

The sealing part (sealing lip) 13 prevents that oil can penetrate from the oil side 14 into the sealing area underneath the sealing part 13 and that oil can reach the air side 12. In order to return oil that has penetrated underneath the sealing part 13 to the oil side 14, the sealing part 13 or its passage is provided on the side facing the shaft 4 with a return conveying device 15. As will be explained in more detail with the aid of FIGS. 2 through 5, the return conveying device 15 is configured as an alternating twist structure with which the medium that has penetrated underneath the sealing part 13 can be reliably returned to the oil side 14.

In the illustrated embodiment according to FIG. 2, the conveying device 15 is formed by elliptical structures 16 that are provided as recesses or projections in the contact side of the sealing part 13 facing or contacting the shaft 4. The elliptical structures 16 are arranged with angular displacement relative to one another. In the illustrated embodiment, the major axes of neighboring elliptical structures 16 are displaced by an angle of 45 degrees relative to one another. The major axes of all elliptical structures 16 intersect one another preferably at the axis 17 of the sealing disk 11 or of the sealing part 13. Because of the angular displacement of the elliptical structures 16, arc-shaped twist sections 18, 19 result on the inner (contact) side of the sealing part 13. Relative to the sealing edge 23 of the sealing part 13, the arc-shaped twist sections 18, 19 extend outwardly from the crossing points 20 through 22 of the elliptical structures 16, respectively. Starting at the crossing points 20 to 22, the arc-shaped sections 18, 19 extend slantedly outwardly in opposite direction relative to one another, respectively; in this way, an alternating twist results. The elliptical structures 16 surround the sealing edge 23 at a minimal spacing.

The return conveying device 15 according to FIG. 3 is embodied as a sine structure 24 that extends about the circumference of the sealing edge 23 at a small spacing thereto. Because of the sine-shaped configuration in the circumferential direction of the sealing part 13, arc-shaped sections 25, 26 are formed that extend slantedly in opposite directions relative to one another and pass into one another.

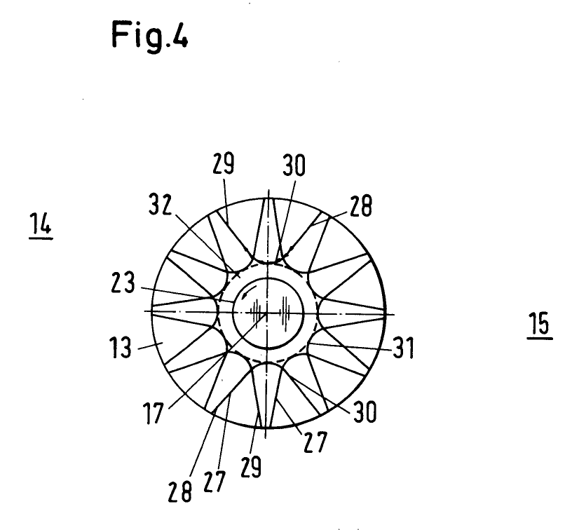

The return conveying device 15 according to FIG. 4 is configured as a half-moon-shaped twist. The sealing part 13 is provided on the side facing the shaft 4 with arc-shaped and wedge-shaped structures (arcs) 27 distributed about the circumference. The arcs 27 each have straight sections 28, 29 passing into one another via arc-shaped sections 30. The straight sections 28, 29 diverge in a direction toward the oil side 14 and are positioned, for example, at an obtuse angle relative to one another.

The arc-shaped sections 30 of the arcs 27 are positioned tangentially relative to a closed ring 31 extending about the axis 17 of the sealing part 13. This ring 31 surrounds a passage 32 for the shaft 4.

The arcs 27 are uniformly arranged about the circumference of the sealing part 13 and staggered relative to one another. The straight sections 28, 29 can intersect one another or can be spaced from one another. Because of the diverging radially outwardly extending sections 28, 29, an alternating twist is generated also in this embodiment.

FIG. 4 shows in an exemplary fashion the path of the medium that penetrates from the oil side 14 underneath the sealing part 13. This medium moves for the assumed counterclockwise rotational direction of the shaft 4 along the section 28 inwardly and reaches the arc sections 30 that forms the vertex of the arc 27. By means of the arc section 30, the medium is guided into the section 29 that conveys the medium away from the sealing edge 23 back to the oil side 14.

The sine structure according to FIG. 3 is also configured such that it conveys medium that has penetrated back to the oil side 14.

The elliptical structures 16 of the embodiment according to FIG. 2 convey the medium that has penetrated from the oil side 14 automatically away from the sealing edge 23 back to the oil side 14.

The sealing edge 23 at the end of the sealing part (sealing lip) 13 is formed by a closed ring that is adjoined by the twist geometry in the direction toward the oil side 14. In the embodiment according to FIGS. 3 and 4, the vertex of the respective structure is located near the closed ring. The half-moon-shaped twist configuration according to FIG. 4 is arranged on the sealing part 13 such that it opens in the direction toward the oil side 14.

The vertex 30 is positioned in the area of the sealing part 13 that rests against the shaft 4.

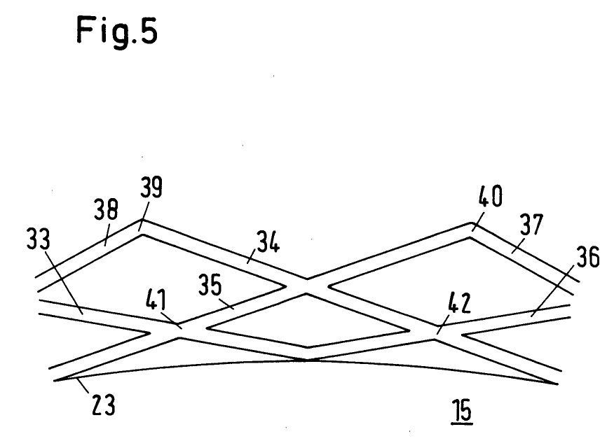

FIG. 5 shows a return conveying device 15 with alternating twist that is comprised of straight structures in the form of crossing straight sections 33 to 38. The sections 34 and 38 as well as 35 and 37 adjoin one another at an obtuse angle at a location spaced from the sealing edge 23. These sections diverge from their transition areas 39, 40 in the direction toward the sealing edge 23 and adjoin the sealing edge. The sections are distributed about the circumference of the sealing edge 23 and cross one another at a spacing from the sealing edge 23. The crossing points 41, 42 have a smaller spacing from the sealing edge 23 in comparison to the transition areas 39, 40. The transition areas 39, 40 and the crossing points 41, 42 are positioned on a circle about the axis 17 (FIG. 4) of the sealing part 13, respectively. In contrast to the configuration of FIG. 4, the sections 33 to 38 extend up to and adjoin the sealing edge 23. In the area of the sealing edge 23 the individual sections of the return conveying device adjoin one another.

As a result of the angularly positioned sections 33 to 38, an alternating twist is formed that ensures that the medium penetrating underneath the sealing part 13 is conveyed away from the sealing edge 23 in the direction toward the oil side 14.

In the described configuration, the return conveying devices 15 extend up to, or into close vicinity of, the sealing edge 23. In this way, it is achieved that the sealing part 13 embodied as a sealing lip is always flushed with new medium so that there is no risk of coking or carbon deposits or this risk is at least significantly reduced. The arcs or legs of the return conveying devices 15 are so flat that the medium can be conveyed reliably away from the sealing edge 23 to the oil side. Leakage is reliably prevented in this way.

The return conveying device can be attached easily on the sealing lip 13 that is bent toward the air side 12. The sealing edge 23 can be formed by a closed ring at the end of the sealing part 13. The return conveying device 15 is provided in the area of the sealing part 13 with which the sealing part 13 rests against the shaft 4.

The different alternating twist structures of the return conveying device 15 can not only be formed by recesses within the sealing part 13 but also by projections.

Aside from using polyfluorocarbon, in particular, polytetrafluoroethylene, the sealing part 13 can also be manufactured from an elastomer or an elastomer-modified PTFE (EMP).

While specific embodiments of the invention have been shown and described in detail to illustrate the inventive principles, it will be understood that the invention may be embodied otherwise without departing from such principles.

What is claimed is:

1. A sealing ring comprising:
a support member;
a sealing lip connected to the support member and configured to rest against a machine part to be sealed;
the sealing lip having a passage for the machine part, wherein the passage points to an air side of the machine part to be sealed and has a contact side provided with a return conveying device for a medium to be sealed at a medium side of the machine part;
wherein the return conveying device is configured as an alternating twist structure.

2. The sealing ring according to claim 1, wherein the alternating twist structure is formed by at least one elliptical structure.

3. The sealing ring according to claim 2, wherein several of the at least one elliptical structure are arranged so as to cross one another.

4. The sealing ring according to claim 2, wherein the at least one elliptical structure surrounds the passage of the sealing lip.

5. The sealing ring according to claim 3, wherein the elliptical structures are angularly staggered relative to one another about a circumference of the sealing lip.

6. The sealing ring according to claim 5, wherein major axes of neighboring ones of the elliptical structures are positioned at an acute angle relative to one another.

7. The sealing ring according to claim 2, wherein the elliptical structures surround at a spacing a sealing edge of the sealing lip.

8. The sealing ring according to claim 1, wherein the alternating twist structure is a sine structure extending at a spacing about a sealing edge of the sealing lip.

9. The sealing ring according to claim 8, wherein the sine structure extends peripherally about the sealing edge.

10. The sealing ring according to claim 1, wherein the alternating twist structure is formed by arc-shaped and wedge-shaped structures opening in a direction toward the medium side.

11. The sealing ring according to claim 10, wherein the arc-shaped and wedge-shaped structures are uniformly distributed about a periphery of a sealing edge of the sealing lip.

12. The sealing ring according to claim 10, wherein the vertex of the arc-shaped and wedge-shaped structures contacts a closed ring surrounding the passage of the sealing lip.

13. The sealing ring according to claim 10, wherein the arc-shaped and wedge-shaped structures have sections diverging in a direction toward the medium side.

14. The sealing ring according to claim 13, wherein the sections are straight.

15. The sealing ring according to claim 10, wherein the vertex of the arc-shaped and wedge-shaped structures are spaced from the sealing edge.

16. The sealing ring according to claim 1, wherein the alternating twist structure is formed by straight structures crossing one another.

17. The sealing ring according to claim 16, wherein the straight structures are positioned at an obtuse angle to one another.

18. The sealing ring according to claim 16, wherein the straight structures extend up to a sealing edge of the sealing lip.

19. The sealing ring according to claim 18, wherein the straight structures intersect one another in the area of the sealing edge.

20. The sealing ring according to claim 1, comprising a sealing disk that is comprised of polyfluorocarbon, wherein the sealing lip is part of the sealing disk.

21. The sealing ring according to claim 20, wherein the polyfluorocarbon is polytetrafluoroethylene.

22. The sealing ring according to claim 1, comprising a sealing disk that is comprised of an elastomer, wherein the sealing lip is part of the sealing disk.

23. The sealing ring according to claim 1, comprising a sealing disk that is comprised of elastomer-modified polytetrafluoroethylene, wherein the sealing lip is part of the sealing disk.

24. The sealing ring according to claim 1, wherein the alternating twist structure is formed by recesses in the sealing lip.

25. The sealing ring according to claim 1, wherein the alternating twist structure is formed by projections of the sealing lip.
